(19) United States
(12) Patent Application Publication
(10) Pub. No.: US 2025/0014293 A1
(43) Pub. Date: Jan. 9, 2025

(54) Artificial Reality Scene Composer

(71) Applicant: Meta Platforms Technologies, LLC, Menlo Park, CA (US)

(72) Inventors: Michael Andrew HOWARD, Twyford (GB); Graham RUTLEDGE, Redwood City, CA (US); Chad TAYLOR, Seattle, WA (US); Francesco CARUCCI, San Jose, CA (US); Timothy JACOBY, Atherton, CA (US)

(21) Appl. No.: 18/069,240

(22) Filed: Dec. 21, 2022

(51) Int. Cl. G06T 19/20; G06T 13/40; G06V 40/20

(52) U.S. Cl. CPC G06T 19/20; G06T 13/40; G06V 40/20; G06T 2219/2004

(57) ABSTRACT

Aspects of the present disclosure are directed to composing an editable artificial reality scene. Implementations include a composer tool for generating editable artificial reality scenes. For example, a scene creator can generate an artificial reality scene and publish the scene such that it can be accessed and/or edited by other users. The artificial reality scene can include scene components, such as an avatar, virtual object, motion dynamics, background, camera perspective, and others. Implementations of a privilege manager can manage access and/or edit privileges for stored artificial reality scenes. For example, the scene creator can define the scope of users that can access and/or edit the original scene and/or define the components of the scene that are editable. In some implementations, an original artificial reality scene can be edited multiple times by multiple users, thus generating multiple edited versions of the original scene.

### TECHNICAL FIELD

The present disclosure is directed to composing an editable artificial reality scene.

### BACKGROUND

Artificial reality systems have grown in popularity with users, and this growth is predicted to accelerate. Artificial reality also provides new techniques for social interactions. For example, modern Internet users share and consume volumes of social media content, such as images, videos, and the like. However, conventional systems lack intuitive and practical mechanisms to create, edit, and/or share content that leverages an artificial reality environment. The more intuitive and realistic feel of artificial reality can enhance the users' experience with such content.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is an example artificial reality environment with multiple user avatars.

FIG. 6A is an example artificial reality scene with a user avatar and virtual objects.

FIG. 6B is an example tool for composing an editable artificial reality environment scene.

FIG. 7 is system diagram for composing and editing an artificial reality scene.

FIG. 8 is a flow diagram illustrating a process used in some implementations of the present technology for composing an editable artificial reality scene.

FIG. 9 is a flow diagram illustrating a process used in some implementations of the present technology for editing a stored artificial reality scene.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to composing an editable artificial reality scene. An artificial reality scene can include components, such as avatar(s), virtual object(s), a background, audio, lighting, a camera/view perspective, motion dynamics for the avatar(s) and/or virtual object(s), and any other suitable scene components. The artificial reality scene can include animation of the avatar(s) and/or virtual object(s) within the defined background from the camera/view perspective, such as movements, expressions, dancing, and other suitable animation. In some examples, the artificial reality scene can also include audio, or textual representations of language, that plays during the animations.

The artificial reality scenes can be stored as a data structure, data blob, or in any other suitable manner. Execution of a stored artificial reality scene can generate a two-dimensional or three-dimensional display of the avatar/virtual object animations within the background from the camera/view perspective that can include output of the audio. For example, an artificial reality system can provide the three-dimensional display (and output the audio) to a user. In other examples, other suitable client devices (e.g., laptops, smartphones, devices with displays, etc.) can provide the two-dimensional, three-dimensional display, and/or audio to user(s).

An example artificial realty scene is a user's avatar playing a virtual musical instrument in a three-dimensional artificial reality environment that includes multiple virtual objects. The scene components can include: the user avatar (e.g., pose, movements, expressions, etc.), the virtual musical instrument (e.g., state, animations), camera position(s) and lighting, audio, the three-dimensional environment (e.g., room, background, outdoor environment, etc.), and the multiple virtual objects. Example avatars for artificial reality scenes include three-dimensional avatars, two-dimensional avatars, or any other suitable virtual user presence. Example virtual objects include three-dimensional object models, two-dimensional images or panels, alphanumeric text, video, or other suitable virtual objects. Example backgrounds include two-dimensional images, there-dimensional models, backgrounds with animations, and any other suitable backgrounds.

Implementations include a composer tool for creating and editing the artificial reality scenes. For example, a library of scene components (e.g., avatars, virtual objects, backgrounds, three-dimensional environments, audio, motion dynamics, etc.) can be predefined to support user customization of artificial reality scenes. In some implementations, an artificial reality environment that includes virtual object(s), avatar(s), a background, and/or audio can be recorded, and the artificial reality scene components can be recognized from the recorded artificial reality environment.

Implementations can store the artificial reality scenes generated and/or edited using the composer tool. For example, the components of an artificial reality scene can be serialized to generate data structure(s) that support storing, sharing, and execution of the artificial reality scenes. In some examples, a stored artificial reality scene can be published, for example to a social application or to any other suitable digital location that permits multiple users to access the published scene. Users can discover, share, access, and execute artificial reality scenes via the publications.

In some examples, the user that generated an original artificial reality scene can be a creator user that sets access and/or edit privileges for the original scene. For example, the creator user can share the artificial reality scene (e.g., via publication to the social application) and/or permit one or more other users to edit the scene. Example access and/or edit restrictions include: access privileges that define which users can view/execute the stored artificial reality scene; edit privileges that define which users can edit the stored artificial reality scene; restrictions on the number of iterative edits that define how many sequential edits can be performed on the stored artificial reality scene; restrictions on the total number of different edited versions of the stored artificial reality scene; restrictions on the individual components of the stored artificial reality scene that define whether individual components are editable; or any combination thereof.

In some implementations, once the artificial reality scene is shared by the creator user, an editing user with edit privileges can load and edit the scene (e.g., via the composer tool). For example, an editing user can, when permitted by the creator user, perform one or more of the following edits using a composer tool: A) replace the creator user's avatar with the editing user's avatar; B) add the editing user's avatar to the composition adjacent to the creator user's avatar; C) substitute or delete any of the multiple virtual objects; D) change, substitute, or edit the three-dimensional environment, such as the room visuals, background, lighting, etc.; E) change, substitute, or edit the audio; F) change or edit the camera position; or G) any combination of these.

In some implementations, portions of a scene can be shared by the scene creator, such as lighting conditions, entities used, or camera positions. Other users can then obtain these scene portions (e.g., from an online scene library, social media source, etc.) and incorporate them into their own scenes.

In some implementations, the editing user can then store and publish the edited scene. For example, the edited scene can be published to the social application, a digital location accessible by multiple users, and the like. Based on the publication, other users can then discover, share, access, and execute the edited artificial reality scene. In some implementations, the edited artificial reality scene can itself be edited by another user to generate another edited version of the artificial reality scene. According, an original artificial reality scene can go through several iterations of edits by multiple editing users.

Implementations permit social interaction via editable and publishable artificial reality scenes. Creator users can control, via access and/or edit permissions, the level of social interaction for an original artificial reality scene. When multiple edited versions of an original artificial reality scene are generated via multiple/iterative edits by users, the multiple versions can share some common thread (e.g., background, virtual object, avatar, motion dynamics, audio, etc.). Given this common thread, the users that edit, publish, and share the multiple versions can achieve a level of connectivity via the similarities among their versions of the artificial reality scene and communicate individuality via the differences among their versions of the artificial reality scene.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

While some conventional software permits customization of sharable media, such as images and/or videos, this conventional software fails to incorporate artificial reality elements to these customizations. In addition, this conventional software also fails to provide access and edit controls for owner or originating users. Thus, a user's sharable media can often be manipulated absent a control mechanism defined by the user.

Implementations include a composer tool for generating editable artificial reality scenes. For example, an originating or creator user can generate an original artificial reality scene and publish the scene such that it can be accessed and/or edited by other users. The artificial reality scene can include three-dimensional components, such as an avatar, virtual object, immersive background, camera perspective, etc. Accordingly, the composer tool supports editable scenes with artificial reality content.

Implementations of a privilege manager can manage access and edit privileges for artificial reality scenes. For example, the creator user of an artificial reality scene can define the scope of users that can access and/or edit the user's original scene and/or define the components of the scene that are editable. Accordingly, implementations permit the owner/originating user control over how the original artificial reality scene is accessed and edited. As used herein a “creator user” can be the user that originally created a scene or scene component or who has gained ownership over such scene or scene component from the original creator.

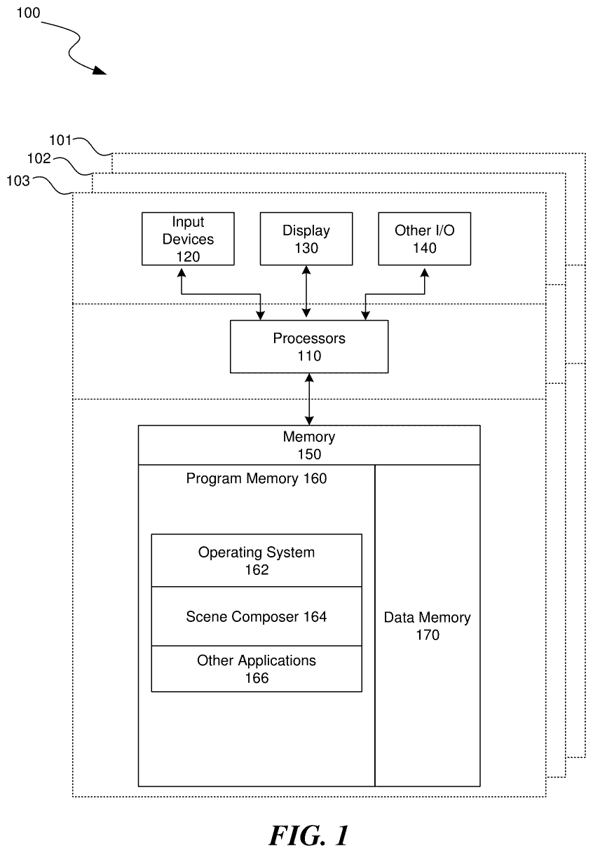

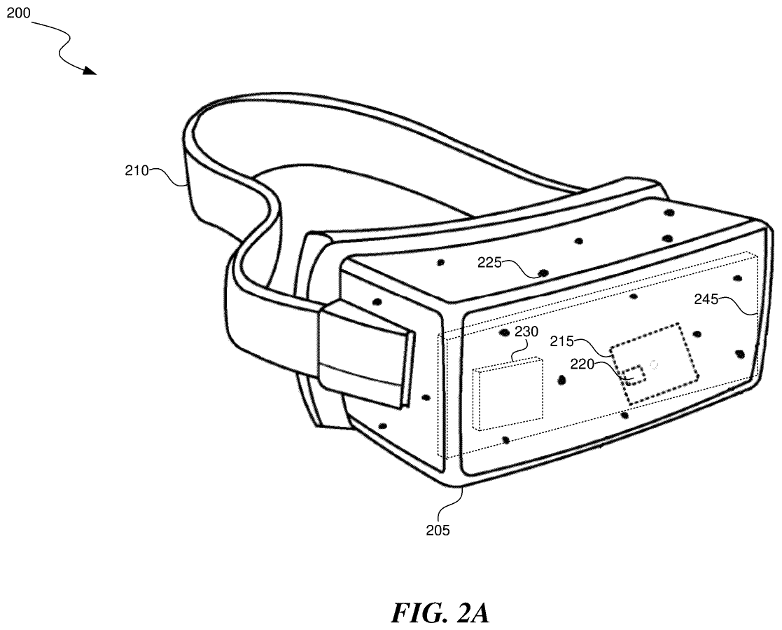

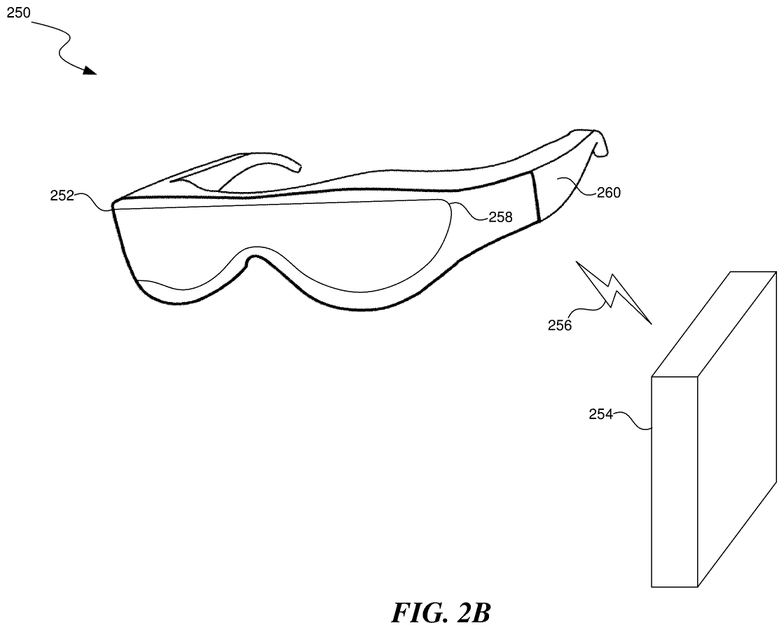

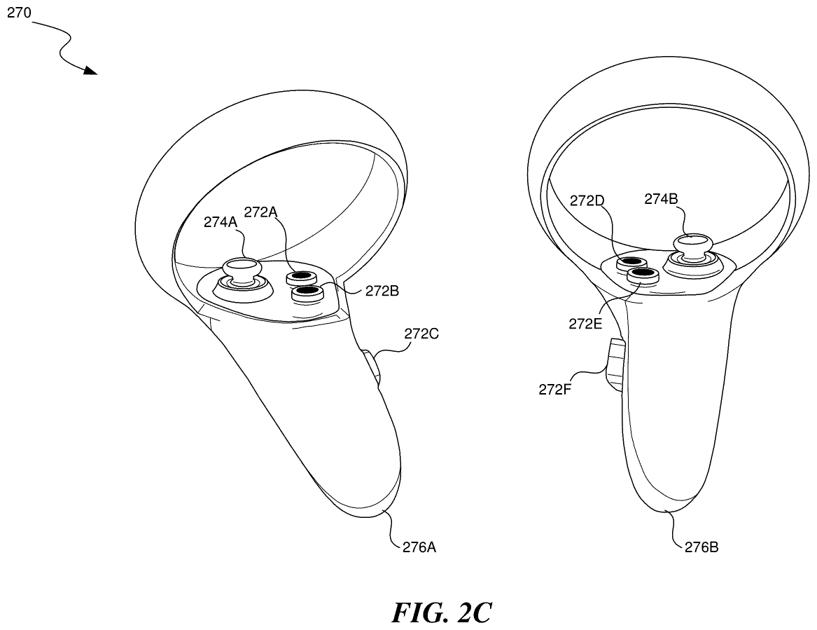

Several implementations are discussed below in more detail in reference to the figures. FIG. 1 is a block diagram illustrating an overview of devices on which some implementations of the disclosed technology can operate. The devices can comprise hardware components of a computing system 100 that compose an editable artificial reality scene. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, scene composer 164, and other application programs 166. Memory 150 can also include data memory 170 that can include, e.g., avatar data (e.g., avatar structure, poses, states, etc.), virtual object data (e.g., virtual object structure, movements, etc.), image, audio, and/or video files, three-dimensional data models, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

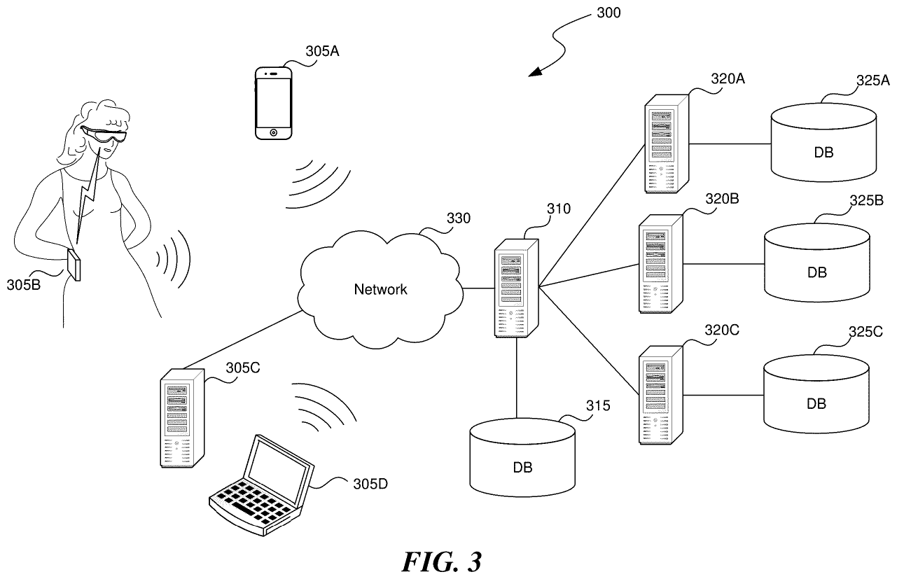

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

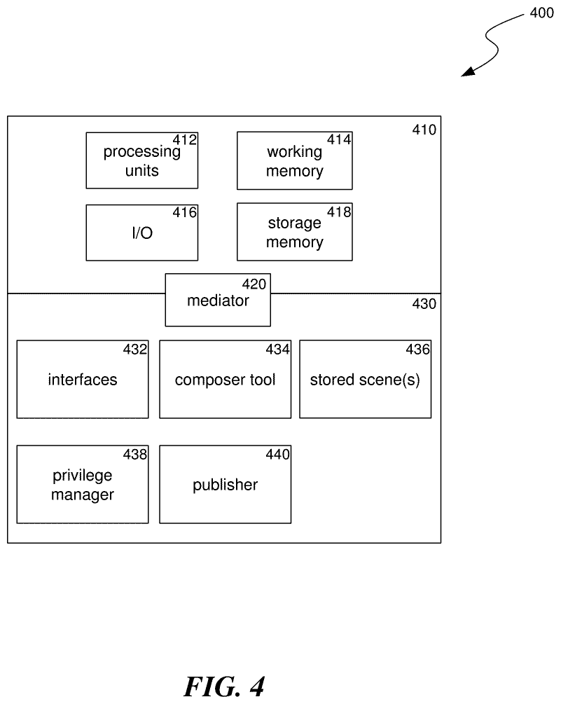

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for composing an editable artificial reality scene. Specialized components 430 can include composer tool 434, stored scene(s) 436, privilege manager 438, publisher 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

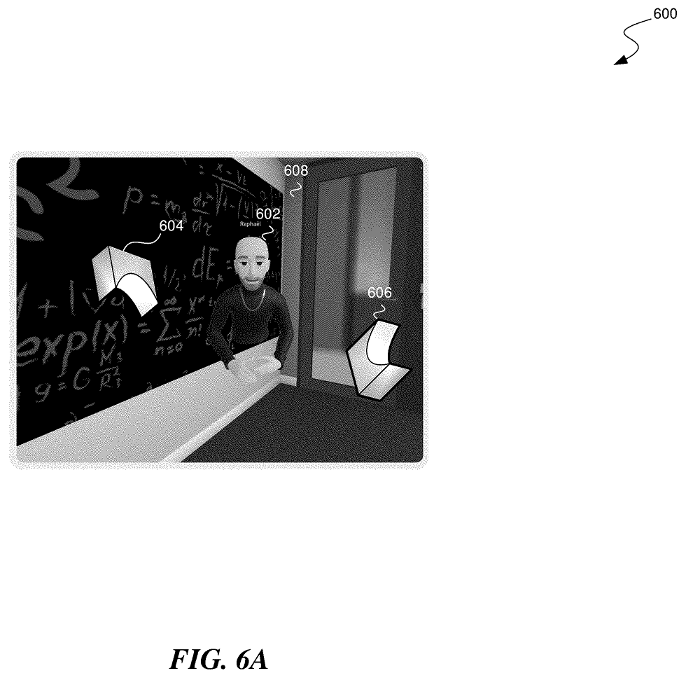

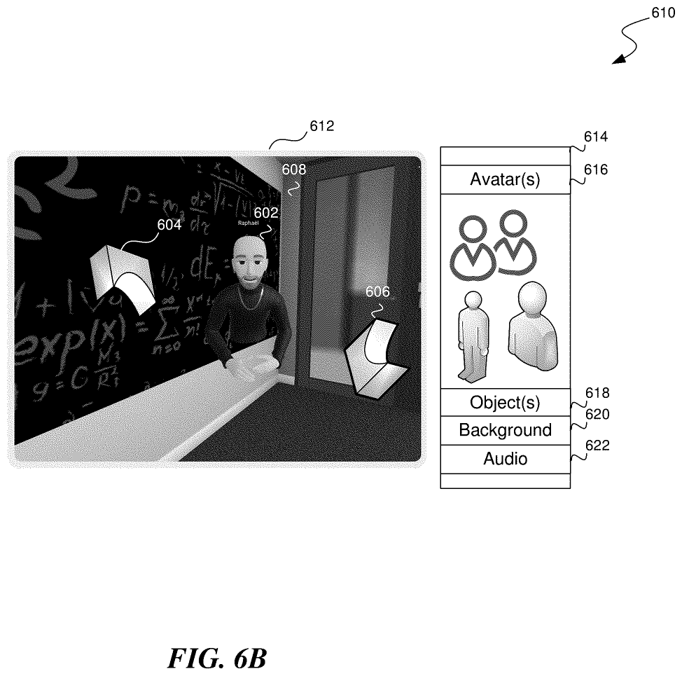

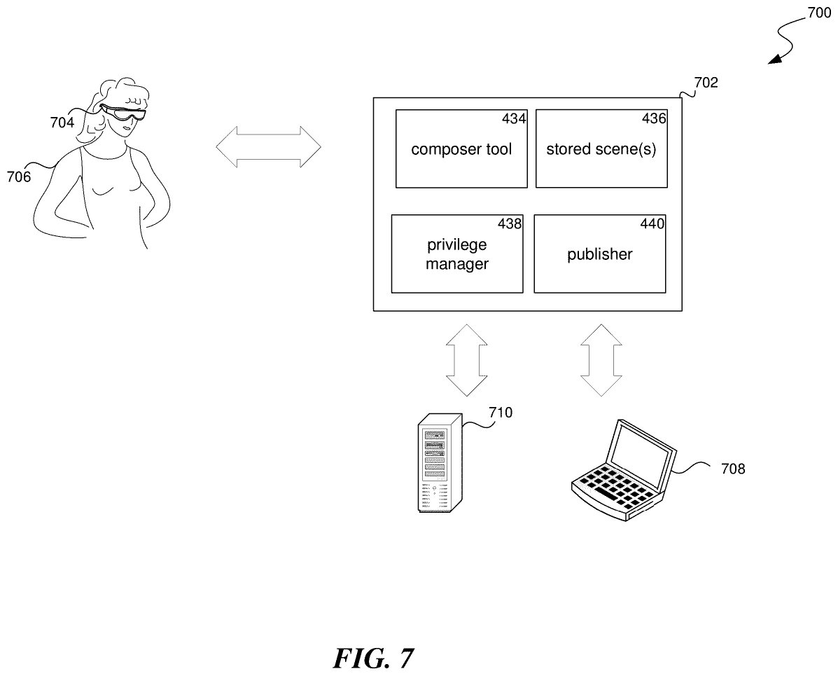

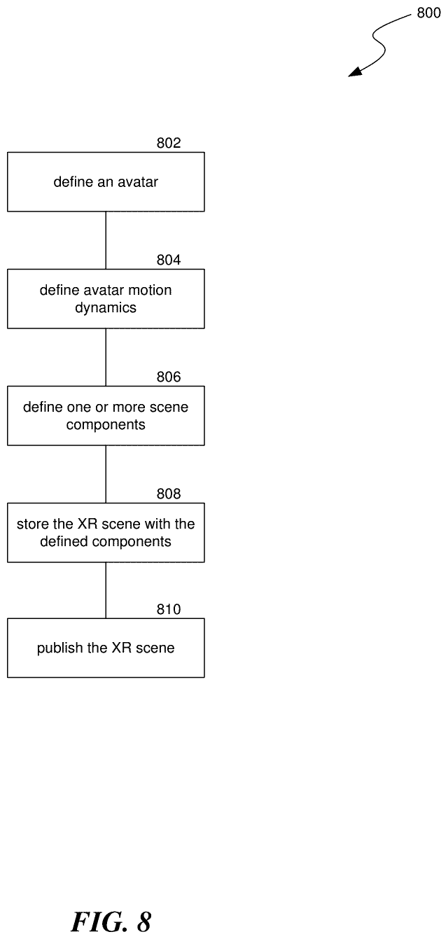

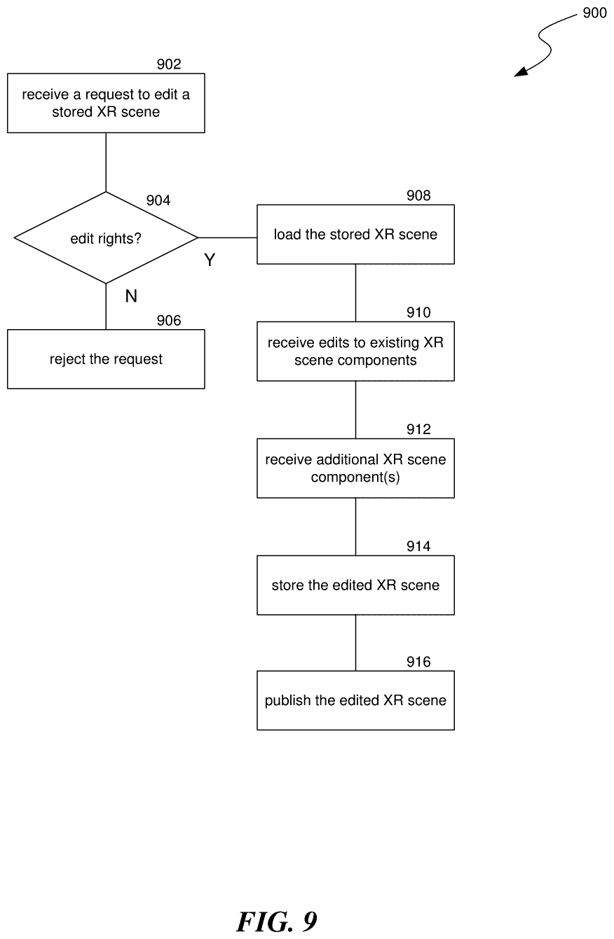

Composer tool 434 is a tool that composes a XR scene. For example, composer tool 434 can provide an interface where a user interacts with XR scene components to define a XR scene, such as avatar(s), virtual object(s), a background, audio, camera position(s), lighting, and the like. A user can define scene components of a XR scene using composer tool 434 and store the generated XR scene as stored scene(s) 436. In some implementations, composer tool 434 can load one or more of stored scene(s) 436 for user editing, and the edited scene can be stored as one of stored scene(s) 436. Additional details on composer tool 434 are provided below in relation to FIGS. 6B, 7, blocks 802, 804, 806, 808, and 810 of FIG. 8, and blocks 908, 910, 912, 914, and 916 of FIG. 9.

Stored scene(s) 436 can include a data structure (e.g., serialized data structure) that store definitions for the scene components that comprise a XR scene. These definitions can include avatar definitions (e.g., structure, poses, etc.), virtual object definitions (e.g., structure, display states, etc.), movement definitions (e.g., avatar movement, virtual object movement, etc.), background definitions (e.g., three-dimensional models, images, etc.), audio and/or video files, and other suitable scene component definitions. Scene composer 436 can generate stored scene(s) 436 and load stored scene(s) 436 for editing. Additional details on stored scene(s) 436 are provided below in relation to FIGS. 6B, 7, block 808 of FIG. 8, and blocks 902, 908, and 914 of FIG. 9.

Privilege manager 438 can manage the access, edit, or other suitable privileges for stored scene(s) 436. For example, a user, such as an owner or originator of a stored scene(s) 436, can define privileges for accessing and/or editing the XR scene. Access privileges can define what users are permitted to execute a XR scene. Edit privileges can comprise scene edit privileges and/or scene component edit privileges. Scene edit privileges can define what users are permitted to edit one or more scene components of a XR scene. Scene component edit privileges can define an edit parameter for one or more of the individual scene components that comprise a XR scene, where the edit parameter indicates whether the individual component can be edited by another user (e.g., non-owner and/or non-originator). Additional details on privilege manager 438 are provided below in relation to FIG. 7 and blocks 902, 904, 906, and 908 of FIG. 9.

Publisher 440 can publish XR scenes for access by users. For example, publisher 440 can publish one or more of stored scene(s) 436 to a social platform. Social platform users with access privilege to a XR scene can execute the XR scene. Social platform users with edit privilege to a XR scene can load the XR scene (e.g., via composer tool 434), edit one or more scene components (e.g., components comprising an editable parameter that permits editing), and store the edited XR scene as one of stored scene(s) 436. Publisher 440 can then publish the edited XR scene for access by social platform users. Additional details on publisher 440 are provided below in relation to FIG. 7, block 810 of FIG. 8, and block 916 of FIG. 9.

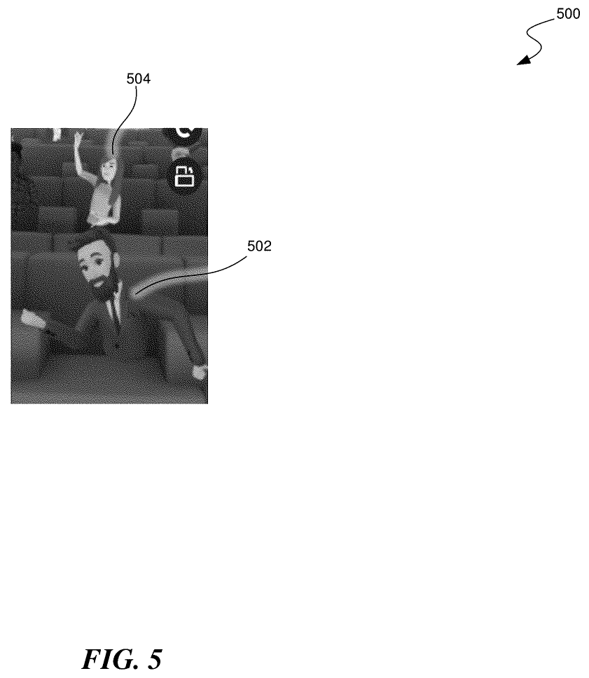

Implementations compose XR scene(s) that, when executed, generate XR environment displays. FIG. 5 is an example artificial reality environment with multiple user avatars. XR environment 500 includes avatar 502 and avatar 504 displayed in an XR environment. XR environment 500 can be a three-dimensional immersive environment displayed to a user via a XR system. Avatars 502 and 504 can move within the XR environment, which is rows of chairs in XR environment 500. In some examples, avatars 502 and 504 can be full body avatars or any other suitable virtual representations of a user.

In some implementations, elements of XR environment 500 can be components of a XR scene. For example, avatars 502 and 504 and their corresponding movements, can be components of a XR scene. In some implementations, the background (e.g., the row of chairs) can also be a scene component of the XR scene. When executed, the XR scene can display (e.g., from a given camera view/perspective in the three-dimensional environment) the movements of avatars 502 and 504 against the background. Some implementations of a XR scene include additional scene components, such as virtual objects, audio, lighting, and other suitable scene components.

FIG. 6A is an example artificial reality scene with a user avatar and virtual objects. XR scene 600 can comprise avatar 602, virtual objects 604 and 606, and background 608. In some implementations, one or more of avatar 602, virtual object 604, virtual object 606, or any combination thereof can comprise motion dynamics (e.g., avatar motion dynamics, virtual object motion dynamics, etc.). For example, a XR scene recorder can record XR scene 600 from a XR environment displayed to a user. Implementations of the XR scene recorder can recognize components of the XR environment as scene components of the XR scene, such as avatar 602, motion dynamics of avatar 602, virtual objects 604, motion dynamics of virtual object 604, virtual objects 606, motion dynamics of virtual object 606, lighting of the XR environment, audio output to the user during the XR environment, and other suitable scene components.

In some implementations, XR scene 600 can be generated and/or edited using a composition tool for XR scenes. For example, a scene composer tool can load a recorded XR environment for editing. In another example, the scene composer tool can generate a XR scene without a recorded XR environment (e.g., from scratch).

FIG. 6B is an example tool for composing an editable artificial reality environment scene. Scene composer tool 610 comprises scene 612 and tool 614. Scene 612 includes avatar 602, virtual objects 604 and 606, and background 608. For example, scene 612 can be a loaded recording of a XR environment. In some implementations, composer tool 610 can automatically recognize avatar 602, virtual objects 604 and 606, and background 608 as XR scene components from the recorded XR environment. In another example, an implementation of a XR scene recorder can automatically recognize the components of scene 612, individual data blobs for each XR scene component can be stored in association with the recorded XR scene, and scene composer tool 610 can load the components of scene 612. Tool 614 can comprise predefined XR scene components for use to generate and/or edit scene 612. For example, tool 614 can be a set of elements shared from scenes created by others and shared to a cloud-based library.

For example, scene 612 can be generated without a XR environment recording using tool 614. Tool 614 comprises avatar element 616, virtual object element 618, background element 620, and audio element 622. Avatar element 616 can comprise predefined avatar model(s) that can be included in scene 612. For example, avatar 602 may be included in scene 612 via avatar element 616. Predefined avatars can include avatar(s) predefined for a given user (or set of users), default avatar(s), avatar(s) that correspond to a given set (e.g., avatars from a gaming application, movie, etc.), or any other suitable predefined avatars. In some implementations, a user interaction with scene composer tool 610 can be a drag-and-drop interaction where the user selects a predefined avatar from avatar element 616, drags the selected avatar to position it within scene 612 (e.g., two-dimensional positioning, three-dimensional positioning, etc.), and drops the selected avatar at the position. Any other suitable user interaction can add predefined avatar(s) from avatar element 616 to scene 612.

Virtual object element 618 can be similar to avatar element 616, however virtual object element 618 may include predefined virtual objects. Predefined virtual objects can include virtual object(s) predefined by a user, default virtual object(s), virtual object(s) that correspond to a given set (e.g., virtual objects from a gaming application, movie, etc.), or any other suitable predefined virtual objects. In some implementations, a user interaction with scene composer tool 610 can be a drag-and-drop interaction where the user selects a predefined virtual object from virtual object element 618, drags the selected virtual object to position it within scene 612, and drops the selected virtual object at the position or onto another element (e.g., applying a predefined motion profile to an avatar already added to the scene). The predefined virtual objects can comprise two-dimensional structures or three-dimensional structural models. Any other suitable user interaction can add predefined virtual object(s) from virtual object element 618 to scene 612.

Background element 620 can provide a background component for scene 612. For example, a user can select background 608 for scene 612 from one or more predefined backgrounds of background element 620. The predefined backgrounds can include user defined background(s) (e.g., backgrounds uploaded to scene composer tool 610 by a user, backgrounds designed by a user, etc.), default background(s), background(s) that correspond to a given set (e.g., backgrounds from a gaming application, movie, etc.), or any other suitable predefined backgrounds. Predefined backgrounds can be two-dimensional (e.g., images), three-dimensional (e.g., 3D images/models), include animations (e.g., animated images/models), or be any other suitable background. A user can select a predefined background from background element 620 to add background 608 to scene 612 or substitute an existing background of scene 612.

Audio element 622 can provide an audio component for scene 612. For example, a user can select audio for scene 612 from one or more predefined audio recordings of audio element 622. The predefined audio can include user defined audio (e.g., audio uploaded to scene composer tool 610 by a user, audio recorded by a user, etc.), default audio, audio that correspond to a given set (e.g., audio from a gaming application, movie, etc.), or any other suitable predefined audio. A user can select predefined audio from audio element 622 to add audio to scene 612 or substitute existing audio of scene 612. Implementations of audio element 622 can include a recording element to record live audio via a client device operated by the user (e.g., XR system, laptop, smartphone, etc.). For example, one or more microphones of the user's client device can be configured to capture live audio, and audio element 622 can add/substitute the live audio to scene 612.

In some implementations, scene composer tool 610 can define avatar motion dynamics for avatar 602. Avatar motion dynamics can include avatar poses over time, avatar facial expressions over time, or any other suitable motion dynamics. A user can generate avatar motion dynamics via scene composer tool 610 by selecting avatar 602 and manipulating the avatar with movements over time. Implementations of scene composer tool 610 can comprise a motion dynamics recording element that records the movements of avatar 602 caused by the user manipulations. In another example, a client device operated by the user (e.g., XR system, laptop, etc.) can capture user motion/movements via one or more cameras, and scene composer tool 610 can translate the captured user motion into avatar movement. For example, one or more machine learning models (e.g., computer vision models) can isolate the user from background in the captured images of a user, detect the isolated user's motion, movements, facial expressions, etc., and translate these detected user motion, movements, and facial expressions to avatar motion dynamics (e.g., avatar poses, avatar facial expressions, avatar movements such as walking, dancing, running, singing, etc.).

In some implementations, the client device operated by the user can capture user audio via one or more microphones (e.g., similar to the recording functionality of audio element 622), and scene composer tool 610 can translate the captured audio into avatar movement, such as facial expressions that lip-sync in accordance with the captured audio (e.g., captured speech or sounds). In another example, scene composer tool 610 can generate avatar movement (e.g., facial expression, such as lip-syncing) from stored audio (e.g., audio loaded via audio element 622).

In another example, scene composer tool 610 can provide predefined avatar motion dynamics (e.g., avatar waving, smiling, running, dancing, etc.) and the user can select one or a sequence of predefined avatar motion dynamics for avatar 602. For example, predefined motion dynamics can include individual dance moves for an avatar, and the user can select a sequence of the individual dance moves to generate a dance sequence for avatar 602. In some implementations, scene 612 is based on a recorded XR environment display, and motion dynamics for avatar 602 can be part of the recorded XR environment display.

In some implementations, virtual objects 604 and/or 606 include virtual object motion dynamics. Virtual object motion dynamics can include virtual object model movements over time, virtual object display state changes over time, virtual object movement in a background over time, or any other suitable motion dynamics. A user can generate virtual object motion dynamics via scene composer tool 610 by selecting virtual object 604 and manipulating the virtual object with movements over time.

Implementations of scene composer tool 610 can comprise a motion dynamics recording element that records the movements of virtual object 604 caused by the user manipulations.

In another example, scene composer tool 610 can provide predefined virtual object motion dynamics (e.g., virtual object display state changes, such a transformations or other suitable animations, virtual object motion patterns, virtual object dances, etc.) and the user can select one or a sequence of predefined virtual object motion dynamics for virtual object 604. For example, predefined motion dynamics can include individual camera moves for a virtual camera, and the user can select a sequence of the individual camera moves to generate a scene capture sequence around virtual object 604. In some implementations, scene 612 is based on a recorded XR environment display, and motion dynamics for virtual object 604 and/or virtual object 606 can be part of the recorded XR environment display.

In some implementations, scene composer tool 610 can include an effects element that supports user addition and/or editing of XR effects to a XR scene. XR effects can include animations, sound effects, visual effects (e.g., blurring, light effects, etc.), filters, and any other suitable effects. In some implementations, XR effects can be added, substituted, and/or deleted in relation to other components of the XR scene, such as avatars and/or virtual objects. For example, a visual effect overlaid over an avatar can be edited, substituted, or deleted.

In some implementations, scene composer tool 610 can include a lighting element that supports user adjustment and/or edits to the lighting of an XR scene. For example, a user can adjust (e.g., increase or decrease) the light of an XR scene. In some implementations, the user can select/define a region or volume of the XR scene and adjust the lighting for this individual region or volume.

Implementations of scene composer tool 610 can generate scene 612 from scratch, load a previously stored XR scene, and/or load a recorded XR environment as a XR scene. Scene 612 can be generated/edited using avatar element 616, virtual object element 618, background element 620, and/or audio element 622. For example, avatar(s), virtual object(s), background(s), audio, and/or motion dynamics can be added to scene 612 or existing components of scene 612 (e.g., existing avatar(s), virtual object(s), background(s), audio, and/or motion dynamics) can be substituted.

When a previously stored XR scene is loaded as scene 612, scene composer tool 610 provides replacements, substitutes, and/or additions for the components of the previously stored XR scene. For example, substitute avatar(s), virtual object(s), background(s), audio, and/or motion dynamics can create an edited XR scene that is then stored for later execution. This edited XR scene can then go through several iterations of edits via different users. The several iterations of edits create several different versions of a XR scene that can share common threads, such as avatar movements, background, audio, virtual objects, etc. In some implementations, the users that perform these edits are connected via a social platform. Accordingly, the several different versions can serve as a mechanism for social interaction among the users.

In some implementations, a user, via scene composer tool 610, can remove or delete components from scene 612 (e.g., a recorded scene, stored scene, etc.). For example, once loaded, components of scene 612, such as avatar(s), virtual object(s), background, audio, motion dynamic(s), etc., can be selected and deleted. User selection/deletion can occur via the individual scene components displayed by scene 612 (e.g., cursors based selection and deletion), scene components listed by elements of tool 614 (e.g., avatar element 616, virtual object element 618, background element 620, and audio element 622), or any other suitable technique.

In some implementations, the stored XR scene can comprise a three-dimensional display (e.g., three-dimensional model with avatar/object movement, audio, etc.), two-dimensional display (e.g., animated image, video, audio, etc.), or any other suitable display. For example, the stored XR scene can be executed and displayed as a three-dimensional display and/or a two-dimensional display to a user via the user's client system (e.g., XR system, laptop, smartphone, etc.). In some implementations, a two-dimensional display can be generated for a three-dimensional XR scene based on an owner user/editor user selection or definition of a camera location within a three-dimensional XR scene. The generated two-dimensional display can be from the perspective of the selected/defined camera location.

FIG. 7 is system diagram for composing and editing an artificial reality scene. System 700 includes XR system 704, user 706, server 702, laptop 708, and computing device 710. Server 702 includes composer tool 434, stored scene(s) 436, privilege manager 438, and publisher 440 of FIG. 4. Users (e.g., owners, editors, etc.) can interact with composer tool 434 to generate/edit stored scene(s) 436. Composer tool 434 can comprise an interface component (e.g., front-end) that is displayed to a user on any suitable device. For example, user 706 can view composer tool 434 via XR system 704. In other examples, users can interact with composer tool 434 via laptop 708 or computing device 710 (e.g., smartphone, desktop, smart home device, Internet of Things device, etc.). Composer tool 434 (or portions of the tool) can execute at server 702, XR system 704, laptop 708, computing device 710, or any combination thereof.

Privilege manager 438 can manage access, edit, or any other suitable privileges for stored scene(s) 436. For example, a creator user can originate one of stored scene(s) 436 and define access and/or edit privileges for the stored scene. Access privileges can define which users can view/execute the stored XR scene. Example access privileges can be public (e.g., any user of a social application), friends (e.g., links connected to the creator user on social graph), portion of a social graph relative to a user (e.g., friends of friends, distance from creator user on social graph, etc.), group access (e.g., access for a set of users that are members of a user group, such as a gaming team, social group, employment group, etc.), allowlist (e.g., explicit list of users permitted for access), blocklist (e.g., explicit list of users that are not permitted access), and any combination thereof. Example edit privileges can be public (e.g., any user of a social application), friends (e.g., links connected to the creator user on social graph), portion of a social graph relative to a user (e.g., friends of friends, distance from creator user on social graph, etc.), group privileges (e.g., edit privileges for a set of users that are members of a user group, such as a gaming team, social group, employment group, etc.), allowlist (e.g., explicit list of users permitted for editing), blocklist (e.g., explicit list of users that are not permitted editing), and any combination thereof.

In some implementations, privilege manager 438 can enforce edit parameters for the XR scene itself, such as restrictions on the number of edit iterations, restrictions on the number of different versions of the XR scene, and restrictions on the individual components of the XR scene that are editable. The user creator (or any other suitable owner) can define the restrictions on the number of edit iterations (e.g., number of edits, in sequence, that can be performed), number of different edited versions of the XR scene (e.g., number of total stored edits using the original XR scene), and restrictions on the individual components of the XR scene that are editable (e.g., edit restrictions on the individual scene components, such as avatars, virtual objects, motion dynamics, background, audio, lighting, camera angle/perspective, etc.).

For example, the restrictions on the number of edit iterations can control how many sequence/chain edits can be made on a XR scene. A stored XR scene can be edited by a first editing user, and the edited XR scene generated can then be edited by a second editing user. This example demonstrates two iterations of edits in a chain/sequence. An creator user can define a threshold number of edit iterations, in sequence, for the original XR scene. Privilege manager 438 can deny requests to edit an edited XR scene that exceeds the threshold.

In another example, the restrictions on the number of different versions of the XR scene can control how many different edited versions of an XR scene can be generated. For example, an original XR scene can be edited twice, by two different users, thus resulting in two edited XR scenes. One of these two edited XR scenes can then be edited by another user in sequence, resulting in a third edited XR scene. A creator user can define a threshold number of total edited versions for an original XR scene. Privilege manager 438 can deny requests to edit an original or edited XR scene that exceeds the threshold.

In another example, restrictions on edits to the individual components of the XR scene can be defined by the creator user. For example, a given scene component, such as an avatar, virtual object, motion dynamics of an avatar and/or virtual object, audio, background, camera perspective, lighting, and the like, can comprise an edit parameter that defines whether other users (e.g., non-owner or non-originator) can edit the given scene component. A first value for the edit parameter may lock the scene component such that it cannot be edited by other users. A second value for the edit parameter may permit the scene component to be edited by other users. Privilege manager 438 and/or composer tool 434 can manage the edit restrictions on individual scene components of a XR scene.

In some implementations, privilege manager 438 verifies/validates edit privileges for a XR scene prior to composer tool 434 loading the XR scene for editing. For example, the edit privileges for a user requesting to edit a stored XR scene can be validated (e.g., relative to the creator user for the stored XR scene on a social graph, etc.). When privilege manager 438 verifies/validates that edit privileges for the requesting user, the XR scene can be loaded by composer tool 434. In some implementations, privilege manager 438 can also provide composer tool 434 the edit restrictions defined for individual scene components of the XR scene. In response to receiving the edit restrictions for scene components, Composer tool 434 can lock the individual scene components that cannot be edited while implementing edits on other scene components.

Publisher 440 can publish a XR scene or edited XR scene to a publicly accessible application, repository, social platform, or execute any other digital publication that permits the published XR scene to be accessed and/or edited by users. In some implementations, publisher 440 can publish a XR scene to users defined by the access restrictions for the XR scene managed by privilege manager 438. Users (e.g., users permitted access) can access the published XR scene, for instance by clicking a uniform resource locator (URL) or other suitable XR scene identifier. In response to the accessing, the XR scene can be executed (e.g., by server 702, XR system 704, laptop 708, computing device 710, or any combination thereof) to display a two-dimensional or three-dimensional display of the XR scene to the user and, in some examples, output audio to the user.

Those skilled in the art will appreciate that the components illustrated in FIGS. 1-5, 6A, 6B, and 7 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 8 is a flow diagram illustrating a process used in some implementations of the present technology for composing an editable artificial reality (XR) scene. In some implementations, process 800 can be performed at a server, XR system, or any other suitable computing system. Implementations of process 800 can be triggered when initializing a XR scene composer tool.

At block 802, process 800 can define an avatar for a XR scene. For example, an avatar can be defined by recording a XR environment that includes an avatar, loading a predefined avatar, or in any other suitable manner. In some implementations, the avatar can be defined using a scene composer tool that comprises predefined avatars. In some implementations, the avatar can be defined when a XR environment is recorded and an avatar in the recorded XR environment is automatically recognized, for example by a XR recording tool and/or the scene composer tool.

At block 804, process 800 can define avatar motion dynamics for the avatar. For example, the avatar motion dynamics can be defined by a user manipulating the avatar via the scene composer tool. In another example, the user's client system (e.g., laptop, XR system, smartphone, etc.) can capture the user via one or more cameras, isolate the user in the captured images, and detect user motions, movements, and/or expressions. The detected user motions, movements, and/or expressions can be translated to avatar motions, movements, and/or expressions (e.g., avatar poses, avatar expressions, etc.).

In some implementations, the scene composer tool can include predefined avatar motion dynamics, and the user can select one or more (e.g., a sequence) of the predefined avatar motion dynamics. In another example, a recorded XR environment can include avatar movements and expressions that are detected as avatar motion dynamics.

At block 806, process 800 can define one or more additional scene components for the XR scene. For example, the additional scene components can include virtual object(s), virtual object motion dynamics, a background, audio, lighting, or any other suitable scene components. The additional scene components can be defined via a composer tool, recognized in a recorded XR environment, or defined in any other suitable manner.

At block 808, process 800 can store the XR scene with the defined components. For example, a data structure can store data blobs, models, audio files, video files, images, and any other suitable data elements for XR scene components. The stored XR scene can be configured such that execution of the XR scene generates a two-dimensional or three-dimensional display of the XR scene to a user that can include audio in some examples.

At block 810, process 800 can publish the stored XR scene. For example, the stored XR scene can be published to a social platform, or any other suitable application accessible by a number of users. The published XR scene can be viewed and selected for editing by one or more of the social platform users.

FIG. 9 is a flow diagram illustrating a process used in some implementations of the present technology for editing a stored artificial reality scene. In some implementations, process 900 can be performed at a server, XR system, or any other suitable computing system. Implementations of process 900 can be triggered when an edit request for a stored XR scene is received.

At block 902, process 900 can receive a request to edit a stored XR scene. For example, the request can be received from a user via the user's client device. In some implementations, the stored XR scene can be published to a social platform, and the user can view the published XR scene and submit the request to edit by clicking a uniform resource locator (URL) or other suitable XR scene identifier.

At block 904, process 900 can determine whether the request comprises edit privileges for the XR scene. For example, edit privileges for the requesting user can be verified or denied. In some implementations, the XR scene was created by a creator user, such as a user that originated the XR scene. The XR scene's edit privileges can be defined by the creator user. Example edit privileges for the XR scene include public (e.g., any user of a social platform), friends (e.g., links connected to the creator user on social graph), portion of a social graph relative to a user (e.g., friends of friends, distance from creator user on social graph, etc.), group access (e.g., access for a set of users that are members of a user group, such as a gaming team, social group, employment group, etc.), allowlist (e.g., explicit list of users permitted for access), blocklist (e.g., explicit list of users that are not permitted access), and any combination thereof.

In some implementations, the requesting user can be compared to the edit privileges for the XR scene (e.g., compare requesting user to creator user on a social graph, allowlist, blocklist, group membership, etc.) to validate or deny the request. When the request comprises the edit privileges to edit the requested XR scene, process 900 can progress to block 908. When the request does not comprise the edit privileges to edit the requested XR scene, process 900 can progress to block 906, where the request is rejected. For example, a message that describes the lack of edit privileges can be transmitted to the requesting client device.

At block 908, process 900 can load the stored XR scene. For example, scene components, such as avatar(s), virtual object(s), motion dynamics for the avatar(s) and/or virtual object(s), a background, a camera/view perspective, audio, lighting, and other suitable scene components can be loaded at a scene composer tool. At block 910, process 900 can receive edits to scene components of the stored XR scene. For example, one or more of the avatar(s), virtual object(s), motion dynamics for the avatar(s) and/or virtual object(s), background, camera/view perspective, audio, and/or lighting can be edited or substituted via user interactions with the scene composer tool. In some implementations, the one or more edits to scene components can comprise removal or deletion. For example, one or more of avatar(s), virtual object(s), a background, audio, or any combination thereof can be removed or deleted from the XR scene.

At block 912, process 900 can receive one or more additional scene components. For example, one or more additional avatar(s), virtual object(s), or motion dynamics for the avatar(s) and/or virtual object(s) can be added via user interactions with the scene composer tool.

At block 914, process 900 can store the edited XR scene with the edited or added components. For example, the data structure that stores data blobs, models, audio files, video files, images, and any other suitable data elements for XR scene components can be modified to store the edits to scene components and/or additional scene components. The edited XR scene can be stored such that execution of the edited XR scene generates a two-dimensional or three-dimensional display of the edited XR scene to a user that can include audio in some examples.

At block 916, process 900 can publish the edited XR scene. For example, the edited XR scene can be published to a social platform, or any other suitable application accessible by a number of users. The published edited XR scene can be viewed and selected for editing by one or more of the social platform users.

In some implementations, the edited XR scene can be selected for editing by an other user. For example, process 900 can be repeated over several iterations such that a number of different edited versions of the original XR scene can be generated. These different versions can be shared among users via publication to the social platform, messaging, or any other suitable sharing mechanism.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for editing a stored 3D artificial reality (XR) scene, the method comprising:
accessing the stored 3D XR scene with scene components comprising at least an avatar, avatar motion dynamics, and a XR environment, wherein execution of the 3D XR scene generates a three-dimensional depiction of the avatar moving according to the avatar motion dynamics defined in the XR environment;
receiving one or more edits for the scene components of the 3D XR scene, wherein the one or more edits comprise at least substituting the avatar with a substitute avatar; and
storing the edited 3D XR scene, wherein execution of the edited 3D XR scene generates a three-dimensional depiction of the substitute avatar moving according to the avatar motion dynamics within the XR environment.

2. The method of claim 1, wherein the scene components of the 3D XR scene further comprise one or more virtual objects and one or more virtual object motion dynamic parameters, and the three-dimensional depiction generated by execution of the 3D XR scene comprises the one or more virtual objects moving according to the one or more virtual object motion dynamic parameters within the XR environment.

3. The method of claim 2, wherein editing the scene components of the 3D XR scene further comprises substituting the one or more virtual objects with one or more substitute virtual objects, and the three-dimensional depiction generated by execution of the edited 3D XR scene comprises the one or more substitute virtual objects moving according to the one or more virtual object motion dynamic parameters within the XR environment.

4. The method of claim 1, wherein editing the scene components of the 3D XR scene further comprises editing the avatar motion dynamics, and wherein the three-dimensional depiction generated by execution of the edited 3D XR scene comprises the substitute avatar moving according to the edited avatar motion dynamics within the XR environment.

5. The method of claim 1, wherein editing the avatar motion dynamics further comprises:
capturing user motion via one or more sensors, wherein at least one of the one or more sensors comprises a camera; and
translating the user motion into avatar motion dynamics.

6. The method of claim 1, wherein editing the scene components of the 3D XR scene further comprises adding one or more additional scene components, and the additional scene components comprise one or more of an additional avatar, an additional virtual object, or any combination thereof.

7. The method of claim 1, wherein the stored 3D XR scene was created by a creator user that defines edit privileges for the stored 3D XR scene, and accessing the stored 3D XR scene further comprises:
receiving, from an other user that is different from the creator user, a request to edit the stored 3D XR scene; and
validating that the other user comprises edit privileges to edit the stored 3D XR scene, wherein the stored 3D XR scene is accessed in response to the validating.

8. The method of claim 7, wherein the edit privileges comprise a scope of users relative to a social graph, and the edit privileges of the other user are validated when the other user is included in the scope of users relative to the social graph.

9. The method of claim 1, wherein the stored 3D XR scene was created by a creator user that defines at least one edit parameter for at least one scene component of the stored 3D XR scene, and wherein a first value for the edit parameter permits the at least one scene component to be edited, substituted, or deleted and a second value for the edit parameter restricts the at least one scene component from being edited, substituted, or deleted.

10. The method of claim 9, wherein the at least one scene component comprises the avatar, and receiving one or more edits for the scene components of the 3D XR scene further comprises:
validating that the edit parameter for the avatar permits substitution of the avatar with the substitute avatar.

11. The method of claim 1, further comprising:
publishing the edited 3D XR scene on a social media platform, wherein the publishing permits a plurality of social media platform users to execute the edited 3D XR scene.

12. The method of claim 1, wherein the avatar motion dynamics comprise at least avatar poses and avatar expressions.

13. A computing system for editing a stored artificial reality (XR) scene, the computing system comprising:
one or more processors; and
one or more memories storing instructions that, when executed by the one or more processors, cause the computing system to perform a process comprising:
storing a XR scene with scene components comprising at least an avatar, avatar motion dynamics, and a XR environment, wherein the XR scene was created by a creator user who defined edit privileges, and execution of the XR scene generates a three-dimensional depiction of the avatar moving according to the avatar motion dynamics within the XR environment;
receiving, from an other user that is different from the creator user, a request to edit the stored XR scene;
validating that the other user comprises edit privileges to edit the stored XR scene;
accessing the stored XR scene in response to the validating;
receiving one or more edits for the scene components of the XR scene, wherein the one or more edits comprise at least substituting the avatar with a substitute avatar; and
storing the edited XR scene, wherein execution of the edited XR scene generates a three-dimensional depiction of the substitute avatar moving according to the avatar motion dynamics within the XR environment.

14. The computing system of claim 13, wherein the scene components of the XR scene further comprise one or more virtual objects and one or more virtual object motion dynamic parameters, and the three-dimensional depiction generated by execution of the XR scene comprises the one or more virtual objects moving according to the one or more virtual object motion dynamic parameters within the XR environment.

15. The computing system of claim 14, wherein editing the scene components of the XR scene further comprises substituting the one or more virtual objects with one or more substitute virtual objects, and the three-dimensional depiction generated by execution of the edited XR scene comprises the one or more substitute virtual objects moving according to the one or more virtual object motion dynamic parameters within the XR environment.

16. The computing system of claim 13, wherein editing the scene components of the XR scene further comprises editing the avatar motion dynamics, and wherein the three-dimensional depiction generated by execution of the edited XR scene comprises the substitute avatar moving according to the edited avatar motion dynamics within the XR environment.

17. The computing system of claim 13, wherein editing the avatar motion dynamics further comprises:
capturing user motion via one or more sensors, wherein at least one of the one or more sensors comprises a camera; and
translating the user motion into avatar motion dynamics.

18. The computing system of claim 17, wherein the edit privileges comprise a scope of users relative to a social graph, and the edit privileges of the other user are validated when the other user is included in the scope of users relative to the social graph.

19. The computing system of claim 13, wherein the creator user defines at least one edit parameter for at least one scene component of the stored XR scene, and wherein a first value for the edit parameter permits the at least one scene component to be edited, substituted, or deleted and a second value for the edit parameter restricts the at least one scene component from being edited, substituted, or deleted.

20. A computer-readable storage medium storing instructions that, when executed by a computing system, cause the computing system to perform a process for editing a stored artificial reality (XR) scene, the process comprising:
storing a XR scene with scene components comprising at least an avatar, avatar motion dynamics, and a XR environment, wherein the XR scene was created by a creator user who defined edit privileges, and execution of the XR scene generates a three-dimensional depiction of the avatar moving according to the avatar motion dynamics within the XR environment;
receiving, from an other user that is different from the creator user, a request to edit the stored XR scene;
validating that the other user comprises edit privileges to edit the stored XR scene;
accessing the stored XR scene in response to the validating;
receiving one or more edits for the scene components of the XR scene, wherein the one or more edits comprise at least substituting the avatar with a substitute avatar; and
storing the edited XR scene, wherein execution of the edited XR scene generates a three-dimensional depiction of the substitute avatar moving according to the avatar motion dynamics within the XR environment.
